(19) United States
(12) Patent Application Publication
(10) Pub. No.: US 2002/0009397 A1
(43) Pub. Date: Jan. 24, 2002

(54) Cuvette stand and stand with cuvettes

(76) Inventors: Taisuke Hirono, Ibaraki-ken (JP); Hiroki Matsui, Shizuoka-ken (JP)

Correspondence Address: LEWIS F. GOULD, JR., DUANE, MORRIS & HECKSCHER, LLP, ONE LIBERTY PLACE, PHILADELPHIA, PA, 19103, US

(21) Appl. No.: 09/873,974

(22) Filed: Jun. 6, 2001

(30) Foreign Application Priority Data
Jun. 6, 2000 (JP) 168584/2000

(51) Int. Cl. B01L 9/06

(52) U.S. Cl. 422/104; 211/74

(57) ABSTRACT

A cuvette stand 6 has a side wall 6e continuously connecting with an insertion portion 6a of a storing portion 7. When a cuvette 1 is taken out, a plate portion 2a of the top of the cuvette contacts with the side wall 6e of the cuvette stand 6 so as to guide the cuvette 1 to an exit (the insertion portion 6a) even if the cuvette 1 is shifted from the center of the insertion portion 6a. Therefore, the cuvette 1 can be taken out without catching somewhere.

### BACKGROUND OF THE INVENTION

This invention relates to a cuvette stand to be used at the time of counting number of leukocyte mixed in blood products.

At the time of counting the number of leukocyte mixed in blood products, it is necessary to mix blood products to be measured and hemolysis · fluorescent dyeing reagent with each other so as to react in advance of counting in a conventional method. FIG. 1 is a view for showing a cuvette (a container for measurement). A cuvette 1, which is the container for inserting blood products and reagent therein, has a hollow main body 2 made of colorless, and transparent plastic and a colored lid 3 made of rubber, as shown in FIG. 1. The main body 2 has a taper portion 2b and a plate portion 2a on the lower end thereof, and has almost circular cone shape facing the lower hand as a whole. The main body 2 is open facing the upper hand, and the lid 3 is attachably and detachably installed on its opening portion.

FIG. 2 is a view for showing a conventional cuvette stand 5. The cuvette stand 5 has a main body comprised so as to unite, made of plastic. As shown in FIG. 2, the main body has a horizontal plate portion 5c and leg portions 5b respectively provided on both ends of the plate portion 5c, formed in the perpendicular direction, and is formed so as to hold its upper plate portion 5c by these leg portions 5b, 5b. In the center of the plate portion 5c of the width direction, eight (8) insertion portions 5a are formed, being arranged in a line at equal intervals. The insertion portion 5a is 9.7 mm in its diameter, for instance, and has such a size that the cuvette 1 can abut on an abutting portion 2d on the taper surface of the outer periphery of the taper portion 2b when the cuvette 1 is inserted and can be located. In a usual inspection, twelve (12) rows of the stands 5 are used. Eight (8)×twelve (12)=ninety six (96) cuvettes 1 are inserted in and located on the twelve rows of the cuvette stands 5.

When the number of leukocyte is counted with the cuvettes 1 and the cuvette stands 5, firstly, ninety six (96) of the empty cuvettes 1, for instance, (the cuvette for exclusive use) are inserted in and located on the cuvette stand 5. Subsequently, hemolysis · fluorescent dyeing reagent is respectively added to the ninety six cuvettes 1. Thereafter, one of the cuvettes 1 is taken out of the cuvette stand 5, the blood is extracted from the blood products, and the extracted blood is added to the cuvette 1 which the reagent is in so as to mix and react, and the cuvette is inserted in and located on the cuvette stand 5. The above-mentioned operation is repeated for the ninety six cuvettes 1 in order. Thereafter, the cuvette 1 in which the reagent and the blood products are reacted is taken out of the cuvette stand 5 so as to centrifuge. And, the cuvette 1 is taken out of the centrifugal so as to set on a micro-leukocytometer. In this machine, laser beams are exposed to the leukocyte staying on the lower hand of the cuvette 1, and the image is analyzed with a CCD camera or the like from the lower hand so as to count the number of the leukocyte.

The conventional cuvette stand 5 has the insertion portion 5a on the plate portion 5c of the upper portion. When the cuvette 1 inserted in the insertion portion 5a, the abutting portion 2d on the taper portion 2b of the cuvette 1 abuts on the cuvette stand and the cuvette is located. But, the insertion portion 5a should be formed so as to pass through the plate portion 2a of the top end of the cuvette 1 and so as not to exceed the maximum diameter of the taper portion 2b. Then, the insertion portion 5a is designed as a circle of 9.7 mm, for instance, and the plate portion 2a is designed as a square of 6 mm (the length of a diagonal 2e of FIG. 1 (b) is about 8.5 mm) in its side, for instance. Then, the difference between the plate portion 2a, passing through when the cuvette 1 is inserted in and taken out of the cuvette stand 5,and the insertion portion 5a is the width of (abutting portion 2d)−(the diagonal 2e of the plate portion) =2·2f, as shown in FIG. 1 (b). The width 2f is about 0.6 mm (that is, the plate portion 2a and the insertion portion 5a form 0.6 mm of minimum space on both sides.). FIG. 4(a) is a view for showing the state of taking the cuvette 1 out of the conventional cuvette stand 5. If the cuvette 1 is shifted 0.6 mm or more from the center at the time of taking as shown in FIG. 4(a), the plate portion 2a of the top end of the cuvette 1 catches the insertion portion 5a, then, it is difficult to take out.

The object of the present invention is to provide cuvette stand wherein the cuvette can be inserted and taken out without catching somewhere and stand with cuvettes wherein cuvette finished operation and cuvette not yet finished operation can be easily differentiated from each other at the time of operation.

### SUMMARY OF THE INVENTION

The invention of claim 1 is cuvette stand capable of inserting and locating a cuvette, comprising:

main body having a plurality of cuvette storing portions;

an insertion portion for inserting and locating said cuvette, provided with said cuvette storing portion; and

side wall provided with said insertion portion so as to continuously connect with said insertion portion and so as to form cuvette storing space thereby;

whereby said cuvette can be guided by said side wall when said cuvette is taken out of said cuvette storing portion.

According to the invention of claim 1, by the structure of the cuvette stand capable of inserting and locating the cuvettes, the cuvette is guided by the side wall at the time of inserting and taking the cuvette and can be taken out without catching somewhere.

The invention of claim 2 is the cuvette stand as set forth in claim 1, wherein said main body is made of transparent member.

According to the invention of claim 2, the cuvette stand is made of transparent member. Then, the whole cuvette inserted in and located on the cuvette stand can be seen and confirmed so as to easily confirm the inside.

The invention of claim 3 is the cuvette stand as set forth in claim 1, wherein a visible portion is formed on side portion of said main body, corresponding to said each cuvette storing space.

According to the invention of claim 3, the side portion of the cuvette stand has the visible portion. Then, the inside of the cuvette can be easily confirmed in the state of inserting and locating the cuvette in and on the cuvette stand.

The invention of claim 4 is the cuvette stand as set forth in claim 3, wherein said visible portion is made of transparent member.

According to the invention of claim 4, the visible portion is made of transparent material. Then, the inside of the cuvette can be easily confirmed in the state of inserting and locating the cuvette in and on the cuvette stand.

The invention of claim 5 is the cuvette stand as set forth in claim 3, wherein said visible portion is comprised of a slit.

According to the invention of claim 5, the visible portion is comprised of the slit. Then, the inside of the cuvette can be easily confirmed in the state of inserting and locating the cuvette in and on the cuvette stand.

The invention of claim 6 is stand with cuvettes in the cuvette stand as set forth in any of claims 1 trough 5, wherein in a plurality of said cuvette storing portions on said main body of said cuvette stand, said cuvettes which number is fewer than the number of said cuvette storing portions are stored.

According to the invention of claim 6, the stand with cuvettes stores the cuvettes, which number is fewer than one of the cuvette storing portion, in a plurality of the cuvette storing portions on the main body. Even if an operation is interrupted or during an operation, then, the cuvette not yet finished operation and the cuvette finished operation can be easily differentiated from each other. Besides, by using the stand with cuvettes of the present invention, high accurate measurement operation can be immediately executed without preparing extra space for the cuvettes.

According to the cuvette stand having the above-mentioned structure, the side wall is provided so as to continuously connect with the insertion portion and so as to form the cuvette storing space. Then, when the cuvette is taken out of the cuvette storing portion, the side wall can guide the cuvette. By forming the cuvette stand by transparent member, the whole cuvette located can be seen through. By forming the visible portion on the side portion of the cuvette stand, corresponding to each cuvette storing space, the inside of the cuvette located can be seen. By forming the visible portion by transparent member, the inside of the cuvette located can be seen through the transparent member. By forming the visible portion by a slit, the inside of the cuvette located can be seen through the slit.

According to the stand with cuvettes having the above-mentioned structure, the cuvettes which number is fewer than one of the cuvette storing portion are stored in a plurality of the cuvette storing portions on the main body of the cuvette stand. Then, the stand always have the storing portion on which the cuvette is not located.

### BRIEF DESCRIPTION OF THE DRAWINGS

FIG. 1 is a view for showing a cuvette relating to the present invention, (a) is a front elevation and (b) is a view for showing its bottom;

FIG. 2 is a view for showing a conventional cuvette stand, (a) is a plane view and (b) is a sectional view seen from arrow A-A in the plane view;

FIG. 3 is view for showing a cuvette stand according to the present invention, (a) is a plane view and (b) is a sectional view seen from arrow B-B in the plane view;

FIG. 4 is a view for showing the state of taking the cuvette out of the cuvette stand, (a) is a view for showing the state of taking out of the conventional cuvette stand, and (b) is a view for showing the state of taking out of the cuvette stand according to the present invention;

FIG. 5 is a view for showing a procedure of taking and locating the cuvette in stand with cuvette, (a) is a view for showing pre-operation, (b) is a view for showing during operation, and (c) is a view for showing post-operation;

FIG. 6 is a view for showing another example of visible portion of the cuvette stand according to the present invention; and

FIG. 7 is a view for showing another embodiment in the cuvette stand according to the present invention.

### DESCRIPTION OF THE PREFERRED EMBODIMENTS

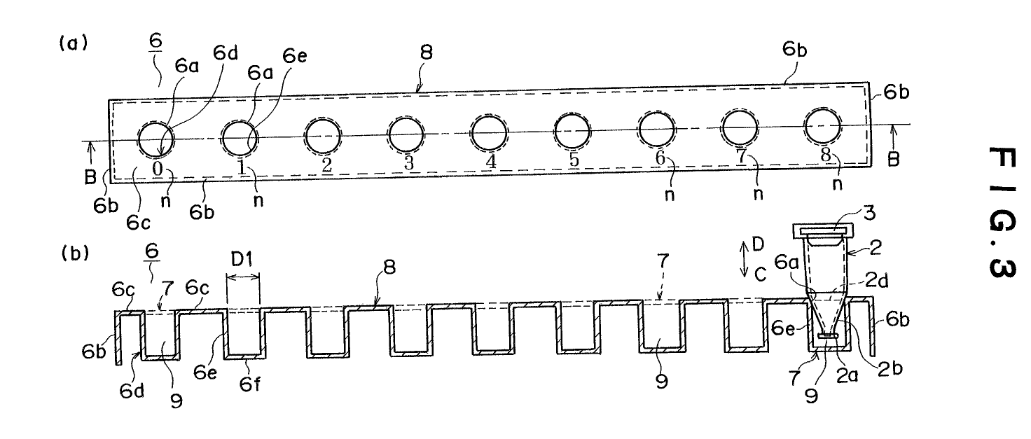

Embodiments of the present invention will now be explained hereinafter, referring to drawings. FIG. 3 is a view for showing an embodiment of the cuvette stand according to the present invention. A cuvette stand 6 is for inserting and locating the cuvette 1 (dedicated cuvette), and has a main body 8 which shape is thin rectangular parallelopiped as a whole, as shown in FIG. 3. The main body 8 is formed so as to unite by transparent plastic (polystyrene in this embodiment). The main body 8 has side outer wall 6b which is outer side in four directions, and has a plate portion 6c which is the upper face of the main body, supported by the side outer wall 6b. On the plate portion 6c, nine (9) cuvette storing portions 7 are formed, and these cuvette storing portions are arranged in a line at equal intervals in the center of the width direction (in up and down direction in FIG. 3(a)). An insertion portion 6a, which diameter is D1, is provided with the cuvette storing portion 7 on the plate portion 6c. On the lower hand of each insertion portion 6a in the perpendicular direction, a hollow cylindrical body 6d, which diameter is D1, the same as the insertion portion 6a, is provided so as to continuously connect with the insertion portion 6a. And, a cuvette storing space 9 in cylindrical shape is formed extending each insertion portion 6a and each cylindrical body 6d. That is, the storing space 9 is enclosed with the insertion portion 6a on the plate portion 6c, a side wall 6e formed by the cylindrical body 6d, and a bottom plate portion 6f. The side wall 6e of the cylindrical body 6d and the insertion portion 6a of the plate portion 6c are communicated with each other, and are unitedly formed so as not to catch somewhere. On the lower hand in the plane direction of each insertion portion 6a which is the upper open of each storing space 9 (on the plate portion 6c), numerals “0” through “8” are affixed as the identification number n corresponding to each insertion portion 6a.

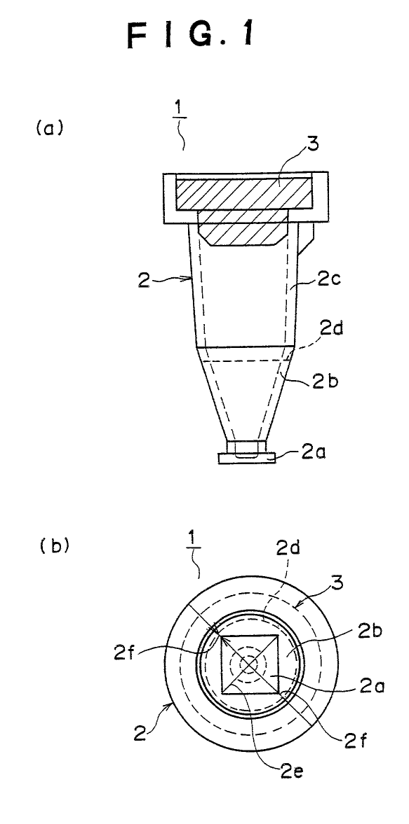

The above-mentioned cuvette 1 is conventionally used, and is the same as one in “BACKGROUND OF THE INVENTION”, then its explanation is omitted (see FIG. 1).

In order to insert and locate the cuvette 1 into and on the cuvette stand 6, the cuvette 1 is inserted into the storing portion 7, as shown in FIG. 3(b). Then, the taper portion 2b of the lower portion of the cuvette 1 and the cuvette stand 6 abut on each other in the abutting portion 2d on the taper portion 2b and the insertion portion 6a of the cuvette stand 6. Then, the cuvette 1 is located in such a manner that the upper portion is above the plate portion 6c of the cuvette stand 6 and the lower portion is entered into the storing space 9 of the lower hand of the plate portion 6c, with the abutting portion 2d as its boundary.

The present cuvette stand 6 is comprised as mentioned before. The operation of counting number of leukocyte mixed in blood products with the cuvette stand 6 will now be explained hereinafter, referring to the drawings.

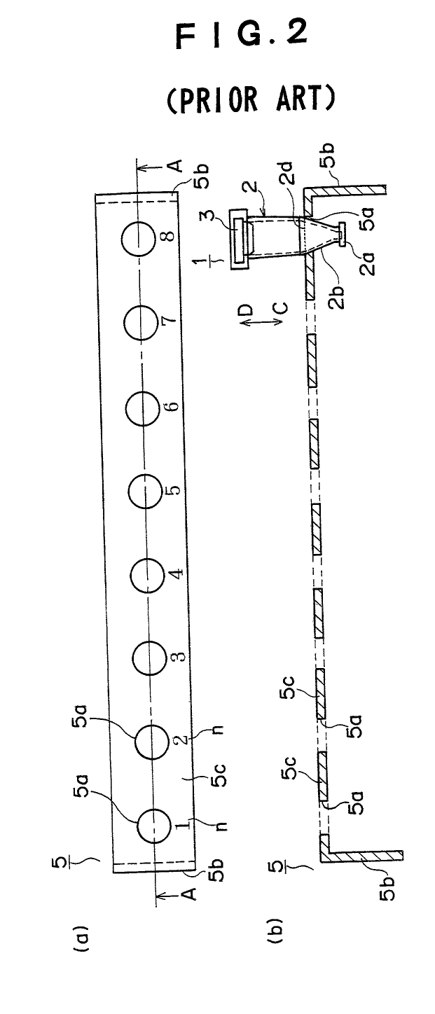

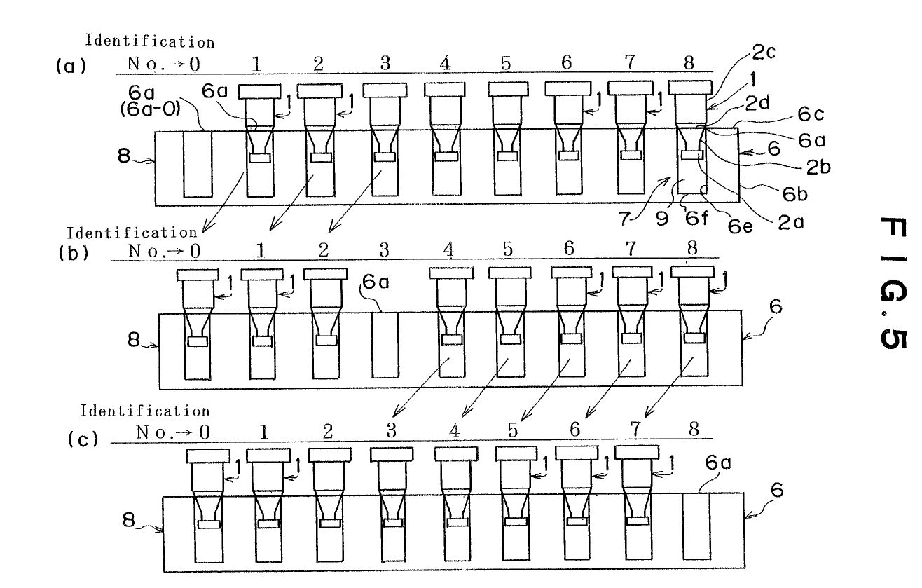

Firstly, twelve (12) rows of cuvette stands 6 are prepared. FIG. 5 is a view for showing a procedure of taking and locating the cuvette in the cuvette stand 6. Usually, measurement is executed for twelve (12) sets with eight (8) cuvettes 1 as a set. But, the present cuvette stand 6 has nine (9) insertion portions 6a one more than eight (8) insertion portions 5a of the conventional cuvette stand 5 (see FIG. 2). As shown in FIG. 5(a), 12 (twelve) rows×8(eight)=ninety six (96) of the cuvettes 1 are inserted in and located on “1” through “8 ” as the identification numbers n of the insertion portions 6a in the storing portions 7 of each cuvette stand 6. The insertion portion 6a of “0” as the identification number n, which is on the utmost left hand of the figure, is a spare insertion portion 6a-0 since no cuvette 1 is located therein.

Subsequently, 100 μL of hemolysis · fluorescent dyeing reagent is added to each of the ninety six (96) cuvettes 1. The cuvette stand 6 and the cuvette 1 are both made of colorless transparent plastic. When the cuvette 1 is located on the cuvette stand 6, the inside of the cuvette 1 can not be seen if one looks down from the upper portion. This is because the lower portion from the abutting portion 2d is entered in the storing space 9 which is in the lower hand of the plate portion 6c of the cuvette stand 6, and besides, the lid 3 of the cuvette 1 is colored. But, by using transparent member for both the cuvette 1 and the cuvette stand 6, the inside of the cuvette 1 can be seen through from the side. Then, a tester can easily confirm to which cuvette 1 the reagent is added by seeing through the inside of the cuvette 1 from the side.

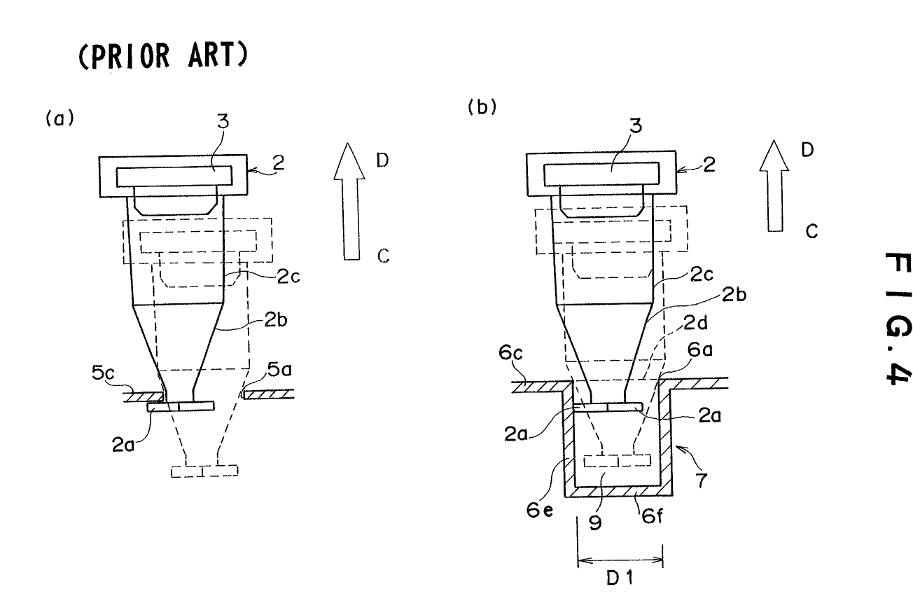

In this way, the cuvettes 1 are taken out of the cuvette stand 6 one by one and reagent is added to each cuvette 1. FIG. 4(b) is a view for showing the state of taking the cuvette 1 out of the cuvette stand 6 of the present embodiment. The cuvette stand 6 has the side wall 6e in cylindrical shape on the insertion portion 6a. Then, the plate portion 2a of the top end of the cuvette contacts with the side wall 6e of the cuvette stand 6 even if the cuvette 1 is shifted from the center of the insertion portion 6a when the cuvette 1 is taken out, as shown in FIG. 4(b). The side wall 6e is continuously formed with the same diameter D1 in its whole length and at the insertion portion 6a. Then, the plate portion 2a of the top end of the cuvette is slipped for the upper hand without catching somewhere, different from the conventional way so as to guide to the exist of the insertion portion 6a. By doing so, the operation of taking ninety six (96) cuvettes 1 out of the cuvette stand 6 can be easily executed several times without catching.

After the reagent is added to all of the ninety six (96) cuvettes 1, blood 100 μL is extracted from the blood products and the blood extracted is added to the cuvette 1 to which the reagent is added, taken out of the cuvette stand 6 so as to mix and react, and thereafter it is inserted in and located on the cuvette stand 6, again. When the cuvette 1 is located, the spare insertion portion 6a-0 (thereafter, the insertion portion 6a of the identification No.n (n=0, 1, 2, 3, . . . 8) is shown as “insertion portion 6a-n” for differentiating each insertion portion 6a from one another.) provided with the cuvette stand 6, is used, as shown in FIG. 5. The blood products is injected into the cuvette 1 taken out of the insertion portion 6a-1 so as to mix and react, and then the cuvette 1 is inserted into and located on the spare insertion portion 6a-0. Then, the cuvette insertion portion 6a-1 in which the cuvette 1 has been inserted becomes empty. Subsequently, the blood products is added to the cuvette 1 taken out of the insertion portion 6a-2, and they are mixed so as to react, and the cuvette 1 is inserted in and located on the insertion portion 6a-1 which newly becomes empty. Then, the insertion portion 6a-2 becomes empty by moving the cuvette 1 to the insertion portion 6a-1, similar to the above-mentioned. Similarly, the blood is added to the cuvette 1 taken out of the insertion portion 6a-n, and they are mixed so as to react, then as shown in FIG. 5 (b), the cuvette 1 is inserted in and located on the insertion portion 6a-(n−1) which newly becomes empty by the operation just before, adjacent to the insertion portion 6a-n in which the cuvette 1 has been inserted, so as to make the insertion portion 6a-n in which the cuvette 1 has been inserted empty. This operation is repeated for eight (8) cuvettes 1, and the operation is executed for eight (8) cuvettes 1 (see FIG. 5(c)).

When the blood products to be mixed with the cuvette 1 which the reagent is in have dark red color as erythrocyte products, the reagent is changed. So, a tester can easily confirm to which cuvette 1 the blood products is added and mixed by seeing through the inside of the cuvette 1 from the side of the cuvette stand 6. Therefore, the operation of inserting and locating the cuvette 1 in and on the cuvette stand 6 using the empty insertion portion has no problem. When the blood products have light yellow color as blood platelet products or blood plasma products, but, the color is almost never changed when reagent is added so as to mix, then it is difficult to differentiate the reagent to which the products have not been yet added from the other. Besides, even if the height of the solution layer in the cuvette 1 is seen, it is also difficult to differentiate since the reagent 100 μL and the blood products 100 μL are both extremely small quantity, and both of small quantity are mixed. Then, the insertion portions 6a (nine insertion portions) which number is one more than the number of a set of the cuvettes 1 to be used for measurement are formed, as shown in FIG. 5. Then, the cuvettes 1 which number is fewer than the number of the insertion portions 6a (eight cuvettes) are located, and the cuvettes 1 are taken out and located on so as to position one empty insertion portion 6a (the cuvette 1 is not located therein) between the cuvette 1 finished operation and the cuvette 1 not yet finished operation. By doing so, easy differentiation is possible, that is, the cuvette finished operation is on the left hand, and the cuvette not yet finished operation is on the right hand, as shown in FIG. 5(b). Even if the operation is interrupted, pre-operation and post-operation can be differentiated by the right and left direction since one of the insertion portions 6a (the insertion portion 6a-3 in FIG. 5 (b)) is always empty. And, at the time of staring next operation also, the operation can easily start from the just right hand of the empty insertion portion 6a (the insertion portion 6a-4 in FIG. 5 (b)). Besides, the number of the insertion portions 6a is made one more than the number of the cuvettes 1 to be inserted into the cuvette stand 6 in the present embodiment, but a plurality of spare insertion portions may be prepared.

The above-mentioned operation of injecting and mixing blood is respectively executed with twelve (12) rows of the cuvette stands 6. Thereafter, the cuvette 1, in which reagent and blood products are reacted, is taken out of the cuvette stand 6 so as to centrifuge. Then, the cuvette 1 is taken out of a centrifugal so as to set onamicro-leukocytometer. In this machine, laser beams are exposed to the leukocyte staying on the lower hand of the cuvette 1, and the image is analyzed with a CCD camera or the like from the lower hand so as to count the number of the leukocyte.

Another embodiment of the present cuvette stand 6 will now be explained hereinafter, referring to the drawings.

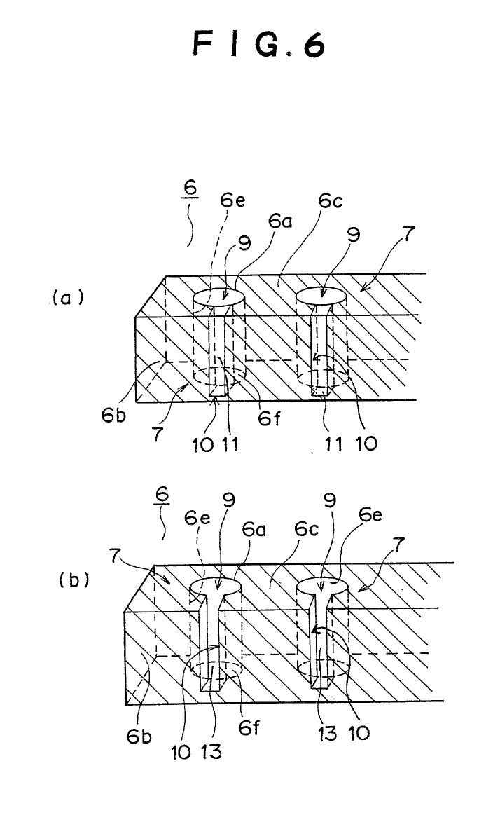

FIG. 6 is a view for showing another embodiment of the cuvette stand 6. In the above-mentioned embodiment of the present cuvette stand 6, the inside of the cuvette can be easily confirm by making the whole by transparent member. But, another method is possible. For instance, even if transparent material can not be used for the whole cuvette stand 6, the portion from a part of the side wall 6e corresponding to each cuvette storing space 9 to the side outer wall 6b of the cuvette stand 6 in the side portion of the cuvette stand 6 may be formed by transparent material 11 so as to make this portion a visible portion 10 for seeing and confirming the contents of each cuvette 1, as shown in FIG. 6(a). Besides, as shown in FIG. 6(b), a slit 13 may be formed on the portion from a part of the side wall 6e corresponding to each cuvette storing space 9 to the side outer wall 6b of the cuvette stand 6 so as to make this portion the visible portion 10 for seeing and confirming the contents of each cuvette 1.

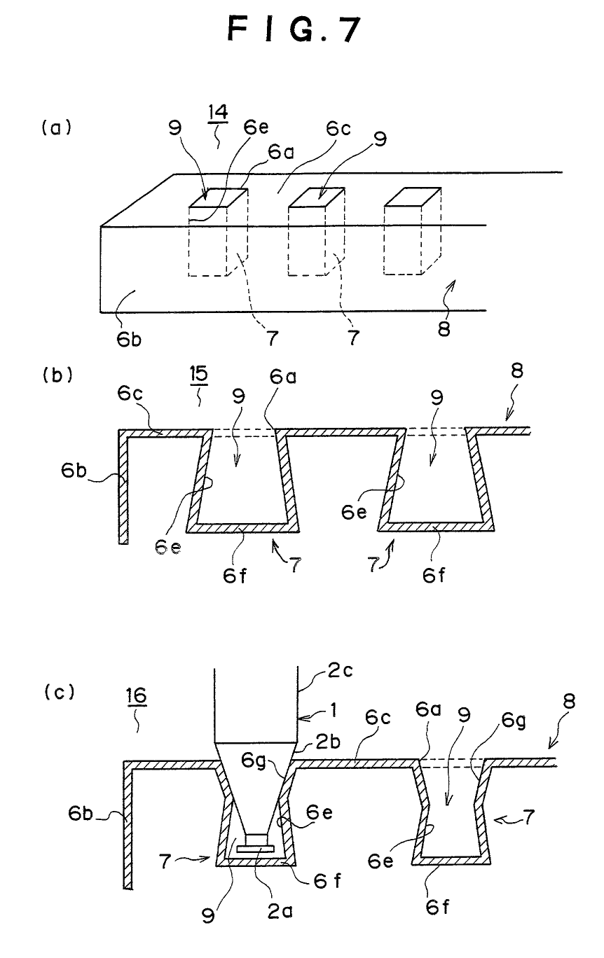

FIG. 7 is a view for showing another embodiment of the cuvette stand 6 (the numerals and marks in FIG. 7 are the portions corresponding to the cuvette stand 6 as shown in FIG. 3 already explained.). In the above-mentioned embodiment, the side wall 6e formed in cylindrical shape is used. But, as shown in FIG. 7 (a), for instance, a cuvette stand 14 may have the insertion portion 6a in the shape of a quadrangle, or the cuvette stand 14 may have the insertion potion in the shape of a triangle or a polygon rather than a triangle as long as it has the side wall 6e forming the storing space 9 continuously connecting with the insertion portion 6a and the side wall can guide the cuvette to the exit by slipping the plate portion 2a thereon without catching the plate portion 2a of the top end of the cuvette. Besides, of course, the insertion portion may be ellipse shape seen from a plane. That is, the plane shape of the insertion portion 6a may not be always circular shape. Furthermore, as shown in FIG. 7 (b), a cuvette stand 15 may have the continuous side wall which sectional area of the storing space 9 expands for the lower hand although the side wall 6e is formed along the direction of inserting and taking, that is, C-D direction in the above-mentioned embodiment. And, as shown in FIG. 7(c), a cuvette stand 16 may have a taper portion 6g having the same inclination as the taper portion 2b of the cuvette on a part of the side wall under the insertion portion 6a in order to settle the cuvette 1 at the time of inserting in and locating on the stand. That is, any cuvette stand is available as long as it has a continuous side wall and the cuvette can be inserted therein and taken out thereof without catching somewhere.

The present invention is explained on the basis of the embodiment heretofore. The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. Cuvette stand capable of inserting and locating a cuvette, comprising:
main body having a plurality of cuvette storing portions;
an insertion portion for inserting and locating said cuvette, provided with said cuvette storing portion; and
side wall provided with said insertion portion so as to continuously connect with said insertion portion and so as to form cuvette storing space thereby;
whereby said cuvette can be guided by said side wall when said cuvette is taken out of said cuvette storing portion.

2. The cuvette stand as set forth in claim 1, wherein said main body is made of transparent member.

3. The cuvette stand as set forth in claim 1, wherein a visible portion is formed on side portion of said main body, corresponding to said each cuvette storing space.

4. The cuvette stand as set forth in claim 3, wherein said visible portion is made of transparent member.

5. The cuvette stand as set forth in claim 3, wherein said visible portion is comprised of a slit.

6. Stand with cuvettes in the cuvette stand as set forth in any of claims 1 trough 5, wherein in a plurality of said cuvette storing portions on said main body of said cuvette stand, said cuvettes which number is fewer than the number of said cuvette storing portions are stored.
